(19) United States
(12) Patent Application Publication
(10) Pub. No.: US 2013/0173469 A1
(43) Pub. Date: Jul. 4, 2013

(54) CHIP CUSTOMIZATION TECHNIQUES

(71) Applicant: Klaus Heinz Goebel, Taipei (TW)

(72) Inventor: Klaus Heinz Goebel, Taipei (TW)

(73) Assignee: Intel Mobile Communications GmbH, Neubiberg (DE)

(21) Appl. No.: 13/342,501

(22) Filed: Jan. 3, 2012

(51) Int. Cl. G06Q 30/00; G06F 12/14

(52) U.S. Cl. 705/44; 726/27

(57) ABSTRACT

Some aspects of the present disclosure provide flexible techniques by which a customer may selectively disable unwanted features, and subsequently apply for a refund corresponding to the disabled feature. In some embodiments, these techniques are value-added for a customer because they allow a customer to flexibly change inventory or individual products to account for market shifts or changes in personal preferences. In addition, these techniques may also be value-added for the manufacturer because the refund request may give the manufacturer some real-time data regarding market conditions and customer preferences in an efficient manner.

### BACKGROUND

Electronic devices, such as mobile handsets for example, include chips sets that include a number of different hardware modules having associated features. For example, features included in some mobile handsets may correspond to digital cameras, PC processors, graphics or sound cards, application processors, connectivity blocks (e.g., FM-radio, Galileo or GLONASS, Bluetooth), memory devices, power management blocks, clock generation blocks, and/or even analog or mixed signal functionality. To provide differentiated products, manufacturers often disable some of these features, in whole or in part, prior to distributing the chip sets to customers. This allows manufacturers to realize economies of scale by manufacturing a single chip set for many different product lines, and selling the different product lines at different price points depending on the particular features that are enabled.

Despite the wide deployment of such differentiable chip sets, until now enabling/disabling of chip features has been a rigid process carried out solely by the manufacturer. In this rigid process, the manufacturer projects quantities of chips required for its various product lines, enables the corresponding features on the chips, and distributes the resultant chips to its distributors and/or end customers accordingly. This rigidity limits the ability of distributors to adapt to dynamic changes in end customer preferences, and could leave distributors with a large inventory of unwanted products. For example, if a state or county government outlaws digital cameras on mobile phones due to privacy concerns, phone vendors in the state or county could be stuck with a large inventory of “camera phones” that they are unable to sell. Individual end customers could also be stuck with camera phones that now, in effect, have limited utility for them. In view of these shortcomings, the inventors have devised improved chip customization techniques as set forth herein.

### BRIEF DESCRIPTION OF THE DRAWINGS

FIG. 1 is a block diagram illustrating a method in accordance with the disclosure.

FIG. 2 is a block diagram illustrating an electronic device that includes one or more features which may be selectively disabled after being distributed from a manufacturer in accordance with the disclosure.

FIGS. 3-5 are block diagrams that collectively illustrate one example of how a chip customization technique may be implemented.

FIG. 6 is a block diagram illustrating an electronic device that includes one or more features which may be selectively disabled after being to distributed from a manufacturer.

FIG. 7 illustrates an example where a commercial customer purchases a batch of electronic devices in the form of memory sticks, disables the features, and applies for a refund in accordance with certain embodiments. In this example, a secret number used in the refund process is a single bit per device.

FIG. 8 illustrates an example where an individual consumer buys a memory stick including content enabled, and subsequently deletes the content and applies for a refund, in accordance with certain embodiments. In this example, a multi-bit secret number for each memory stick is used in the refund process.

FIG. 9 illustrates an example of a mobile communication device, such as a mobile handset, in accordance with the disclosure.

FIG. 10 illustrates an example of a wireless communication network in accordance with the disclosure.

### DETAILED DESCRIPTION

One or more implementations of the present invention will now be described with reference to the attached drawings, wherein like reference numerals are used to refer to like elements throughout. The drawings are not necessarily drawn to scale.

In contrast to conventional enabling/disabling techniques that are rigidly carried out solely by the manufacturer, aspects of the present disclosure provide flexible techniques by which a customer may selectively disable unwanted hardware, software, or content features, and subsequently apply for a refund corresponding to the disabled feature. These techniques may be value-added for a customer because they allow a customer to flexibly change inventory or individual products to account for market shifts or changes in personal preferences. In addition, these techniques may also be value-added for the manufacturer because the refund request may give the manufacturer some real-time data regarding market conditions and customer preferences in an efficient manner.

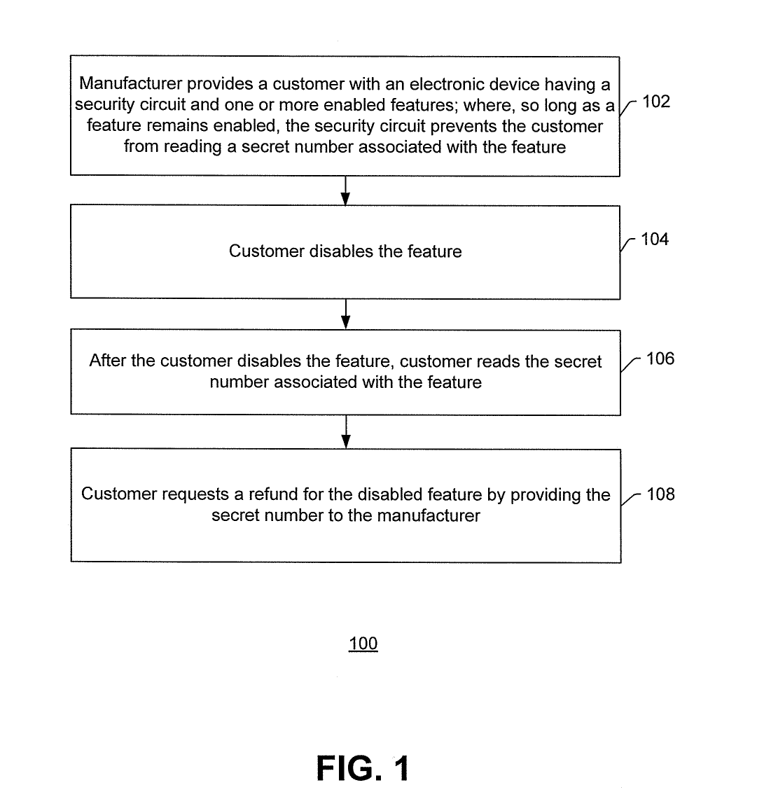

FIG. 1 is a flow chart illustrating a method 100 in accordance with the disclosure. Method 100 starts at 102, when a manufacturer provides a customer with an electronic device, which has a security circuit and one or more enabled features. So long as a feature is enabled, the security circuit prevents the customer from reading a secret number associated with the feature.

After receiving the electronic device, the customer determines that he or she no longer desires the feature and, hence, disables the feature at 104.

At 106, after the customer has disabled the feature, the customer reads the secret number stored in the electronic device. Prior to the feature being disabled, the customer was unable to read the secret number from the electronic device.

At 108, the customer makes a refund request for the feature that has now been disabled. To ensure that the refund request is proper (e.g., that the feature has, in fact, been disabled), the customer provides the secret number to the manufacturer, often along with a device or chip identification number that identifies the electronic device. Thus, because the customer is able to provide the secret number (which is unreadable unless the customer has disabled the feature), the manufacturer is assured that the requested refund is, in fact, proper. So long as the refund request is proper, the manufacturer may issue the refund to the customer.

FIG. 1's methodology and other techniques disclosed herein may be applied to a broad variety of product features, a few examples of which are now described. It will be appreciated that these examples are in no way limiting, but rather they are provided merely to set forth a few ways in which the disabling techniques may be used. In some embodiments, the disabled feature may relate to chipsets for digital cameras. For example, the entire camera chipset may be disabled, specific camera resolutions may be disabled, video and/or video resolutions may be disabled, and/or any image post processing features may be disabled. For PC processors, certain clock frequencies may be disabled. For graphics or sound chipsets, 3D graphics capabilities, graphics resolutions, surround sound capabilities, and/or video outputs may be disabled. For application processors, nearly all features may be disabled, individually or as a whole. For communications connections, FM-radio, Galileo or GLONASS standards, and/or Bluetooth connectivity may be disabled. For memory devices, entire memory arrays or parts of memory arrays may be disabled (e.g., a 128 megabit (Mb) flash chip may be reconfigured to a 96 Mb, 64 Mb, or 32 Mb device). The disabling functionality may also be used for power management chip, clock generation chips, data converters, and even analog or mixed-signal chips.

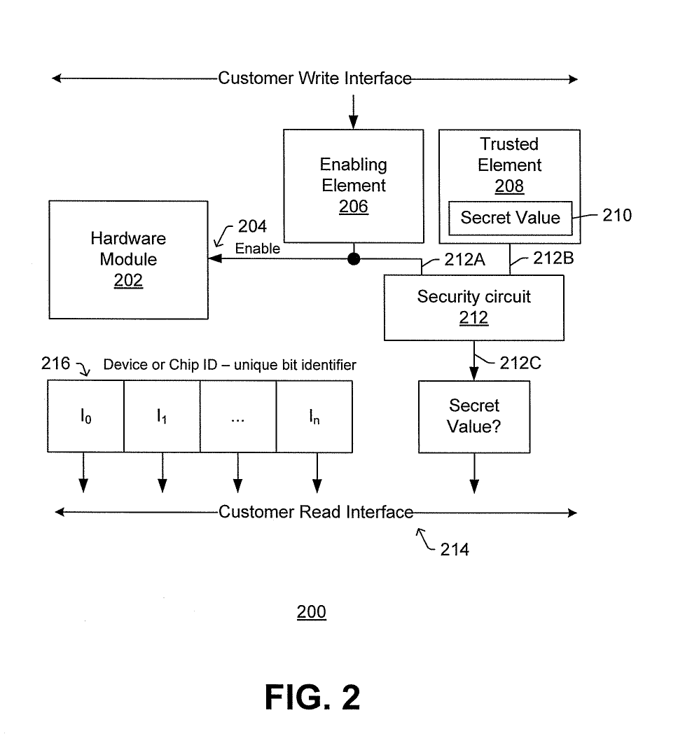

FIG. 2 illustrates a block diagram for an exemplary electronic device 200, which is suited to implement FIG. 1's methodology. Electronic device 200 may include a hardware module 202 associated with a feature, such as an FM Radio feature or other communication feature, for example. Hardware module 202 has an enable terminal 204 that controls whether the feature is enabled or disabled. An enabling element 206, such as a one-time programmable (OTP) element, memory element, or other stateful element for example, may be coupled to enable terminal 204, wherein a state of enabling element 206 controls whether the feature is enabled or disabled.

A trusted element 208, such as an OTP element, memory element, or other stateful element for example, stores a secret value 210 therein. Secret value 210 may correspond to a random or pseudorandom value known only to the manufacturer, and may be a single-bit or multi-bit digital value.

A security circuit 212 has respective inputs 212A, 212B coupled to enabling element 206 and trusted element 208, respectively, and has an output terminal 212C coupled to a customer read interface 214. Based on the state of enabling element 206, security circuit 212 may selectively prevent or allow reading of secret value 210 stored in trusted element 208. Thus, so long as the feature is enabled via enabling element 206, security circuit 212 may prevent a customer from reading secret value 210 via customer read interface 214. After the feature has been disabled (by changing the state of enabling element 206), security circuit 212 allows the customer to read secret value 210 via customer read interface 214.

To request a refund after the feature has been disabled, the customer may provide secret value 210 (along with a device or chip ID 216) to the manufacturer. Upon receiving the refund request, the manufacturer may lookup the device or chip ID, and verify whether secret value 210 for the disabled feature is the correct value. In this way, electronic device 200 allows customers to selectively disable features after having received the electronic device, and allows a manufacturer to provide refunds to customers who are able to demonstrate that they have disabled the one or more features by providing the corresponding secret value(s).

Security circuit 212 may take many different forms, depending on the particular implementation. For example, if secret value 210 is a single bit, security circuit 212 may be a single transistor (e.g., n-type transistor) whose gate is coupled to enabling element 206 and whose source and drain are coupled to trusted element 208 and customer read interface 214, respectively. In this case, if enabling element 206 is set to a logical “1”, the single (e.g., n-type) transistor couples trusted element 208 (and thus secret value 210) to customer read interface 214. On the other hand, if enabling element 206 is set to a logical “0”, the channel of the single (e.g., n-type) transistor is in a high-impedance state to prevent trusted element 208 (and thus secret value 210) from being read at customer read interface 214. In other examples, security circuit 212 may be a single p-type transistor, multiple transistors, a digital logic circuit, a state machine, or an analog circuit.

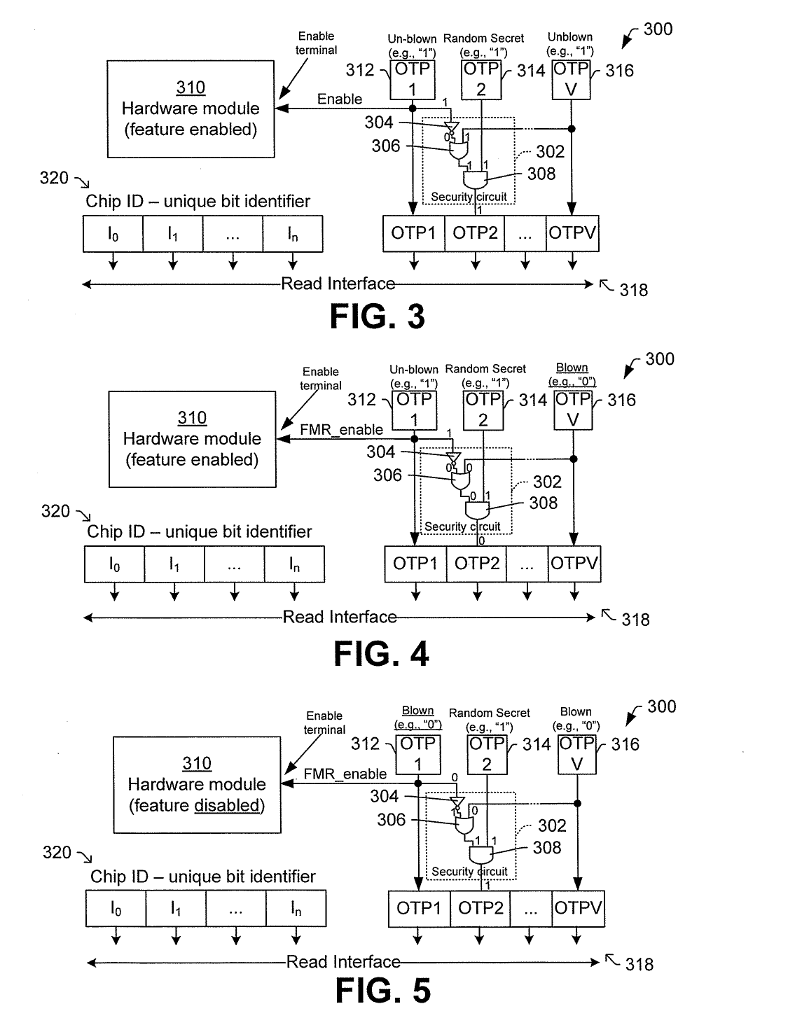

Turning now to FIG. 3, one may see an example where an electronic device 300 includes a security circuit 302 in the form of a digital logic circuit. FIG. 3's security circuit 302 may include an inverter 304, a logical-OR gate 306 and a logical AND-gate 308; however, it will be appreciated that any number of other circuits could also achieve the desired functionality. Although many other circuits could also achieve the desired functionality, FIG. 3's embodiment is efficient in that it does not require the use of complex cryptographic algorithms, and it consumes only a small area on an integrated circuit.

Like FIG. 2's electronic device 200, FIG. 3's electronic device 300 also includes a hardware module 310, an enabling element 312, and a trusted element 314. In FIG. 3's example, the enabling and trusted elements 312, 314 are implemented as one-time programmable (OTP) elements (e.g., fuses, anti-fuses, poly-fuses, laser fuses, non-volatile memory cells with appropriate logic). Compared to multi-time programmable elements (e.g., registers or random access memory), OTP elements offer an additional layer of security in that OTP elements assure that customers who disable a function, for example by blowing a fuse on chip, are unable to re-enable the function at a later time. Electronic device 300 also includes a verification OTP element 316, which may be set after verification of the electronic device is complete at the manufacturer.

FIG. 3 shows the electronic device 300 during final testing as carried out by a manufacturer. Electronic device 300, while undergoing final testing, has the feature enabled by virtue of the first OTP element 312 being set to an enabling state. In this example, the enabling state corresponds to an un-blown state of a fuse, as represented by a logical “1” value, although in other embodiments an un-blown fuse could have a logical “0” value. A secret (e.g., random or pseudo-random) value is stored in the second OTP element 314. For purposes of understanding, FIG. 3's example shows this secret value being a logical “1”, but this secret value may be any number including a multi-bit number. During final testing, the manufacturer may leave verification OTP 316 un-blown (e.g., logical “1”), which passes a logical “1” through OR-gate 306 so AND-gate 308 outputs the correct secret value to OTP2 on customer read interface 318. Thus, the manufacturer may readout the secret value so it may be stored for later look-up.

FIG. 4 shows electronic device 300 after being shipped to the customer with the feature enabled. Prior to shipment, the manufacturer has blown the verification OTP element 316 (e.g., verification OTP element changes to a logical “0”). Because the verification OTP is a logical “0”, OR-gate 306 in security circuit 302 now continuously presents a logical “0”, such that AND-gate 308 continuously presents a logical “0” to OTP2 on read data interface 318. Thus, when OTP2 is read, it will return a logical “0” regardless of the actual secret value stored in trusted element 314. In this way, security circuit 302 prevents a user from reading the secret value stored in trusted element 314. Hence, in FIG. 4's state, the customer is free to use the enabled feature at their leisure, but they are unable to read the secret value and hence, are unable to request a legitimate refund.

In the exemplary electronic device 300 of FIG. 5, the customer has determined that it no longer wants the functionality of the enabled feature, and thus, the customer blows enabling OTP element 312 (e.g., setting it to a “0” state). Thus, after the feature is disabled (by changing the state of the enabling element 312), OR-gate 306 outputs a logical “1”, such that AND-gate 308 in security circuit 302 allows a customer to accurately read the secret value stored in trusted element 314. If a “1” is stored in 314, AND-gate 308 delivers a logical “1” to OTP2; and conversely if “0” is stored in 314 AND-gate 308 delivers a logical “0” to OTP2 on customer interface 318. Hence, the customer may subsequently provide the secret value (which was previously known only to the manufacturer) along with the device or chip identification number 320 to the manufacturer in the refund request, but only after fuse 312 is blown.

It will be appreciated that, although FIGS. 2-5 show only a single hardware module with an associated feature, in many embodiments there may be a plurality of hardware modules associated with respective features, any and/or all of which may be selectively enabled/disabled. Also, the features in FIGS. 2-5 are not limited to hardware features, but may include software and/or content features as well.

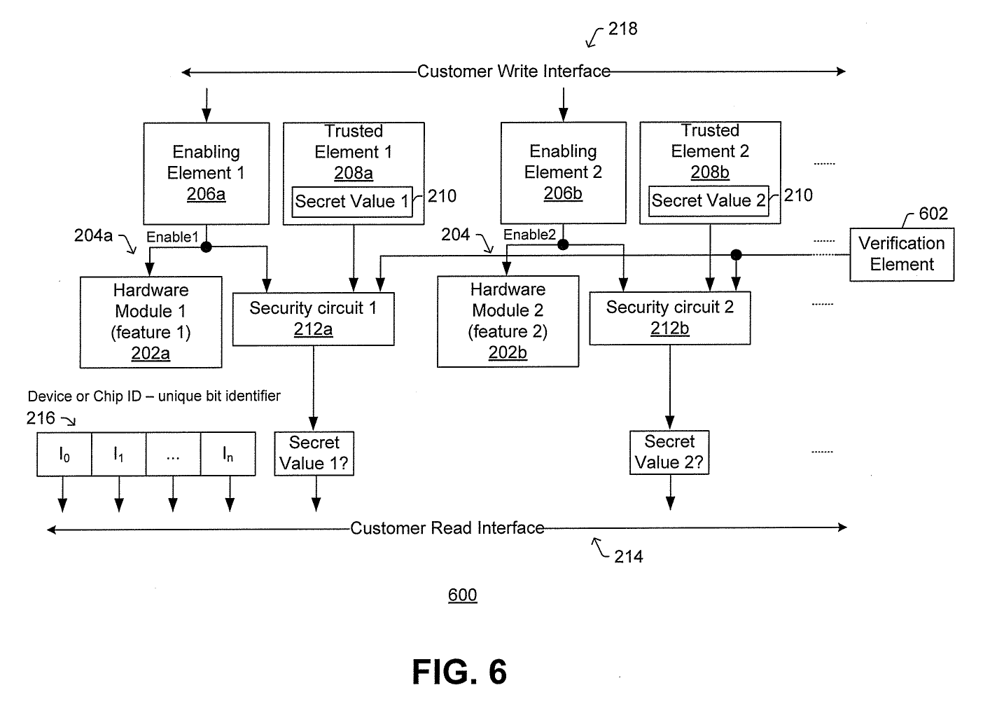

FIG. 6 shows an example of an electronic device 600 having a plurality of hardware modules with respective features. In this case, the plurality of hardware modules includes first and second hardware modules (202a, 202b) with corresponding first and second features, but may easily be extended to any number of hardware modules. For each hardware module (e.g., 202a, 202b) there may be a corresponding enabling element (e.g., 206a, 206b, respectively), a corresponding trusted element (e.g., 208a, 208b, respectively), and a corresponding security circuit (e.g., 212a, 212b, respectively), which are operably coupled as shown. A verification element 602 is coupled to an input terminal for each of the plurality of security circuits (e.g., 212a, 212b).

While device 600 is in final testing at a manufacturer, verification element 602 may be in a first state (e.g., un-blown state), which may allow the manufacturer to read respective secret values from respective trusted elements. Prior to providing the device to a customer, the manufacturer may change the state of the verification element (e.g., to a blown state), which may induce a change in the security circuits (e.g., 212a, 212b) to prevent accurate readout of the secret values stored in the trusted elements (e.g., 208a, 208b).

Device 600 is then shipped to a customer with the one or more of the features enabled. If the customer determines he or she no longer desires a feature, the customer may change the state of the corresponding enabling element via customer write interface 218. At this point, the secret value associated with that feature is readable, however the secret values for any still enabled features are still unreadable. Hence, the customer may request a refund for the disabled features, and the manufacturer has assurances that the customer has actually disabled the feature and is entitled to the corresponding refund. If multiple features are included on the device, there may also be a separate identification number for each feature, thereby providing differentiated refund levels for the features on each device.

It will be appreciated that customer read and write interfaces 214, 218 may take a number of different forms, depending on the implementation. For example, customer read and write interfaces 214, 218 may be accessed via a graphical user interface (GUI), such as an LCD or LED screen, on the electronic device itself. In other embodiments, customer read and write interfaces 214, 218 may be accessed via a web-interface. In many of these embodiments, the electronic device will include current or voltage sources to change the state of an OTP element (e.g., to blow a fuse or anti-fuse), based on user input entered through customer write interface 218. Further, customer read or write interfaces 214, 218 may be a hardware port that is more easily accessed by a manufacturer or OEM (e.g., via an IC tester), which may make the feature disabling techniques more well-suited for OEMs compared to individual end customers. All such variations are contemplated as falling within the scope of the present disclosure.

There may be one or more OTP elements that simultaneously disable all features on the entire device. One may think of this as a type of “e-waste” management procedure, where a customer wants to dispose of the electronic device and prevent others from accessing any sensitive personal or business information in the electronic device. This could be achieved by the customer changing the state of one or more OTP elements, which could disable all features on the electronic device, and also possibly prevent reading of any data from the electronic device.

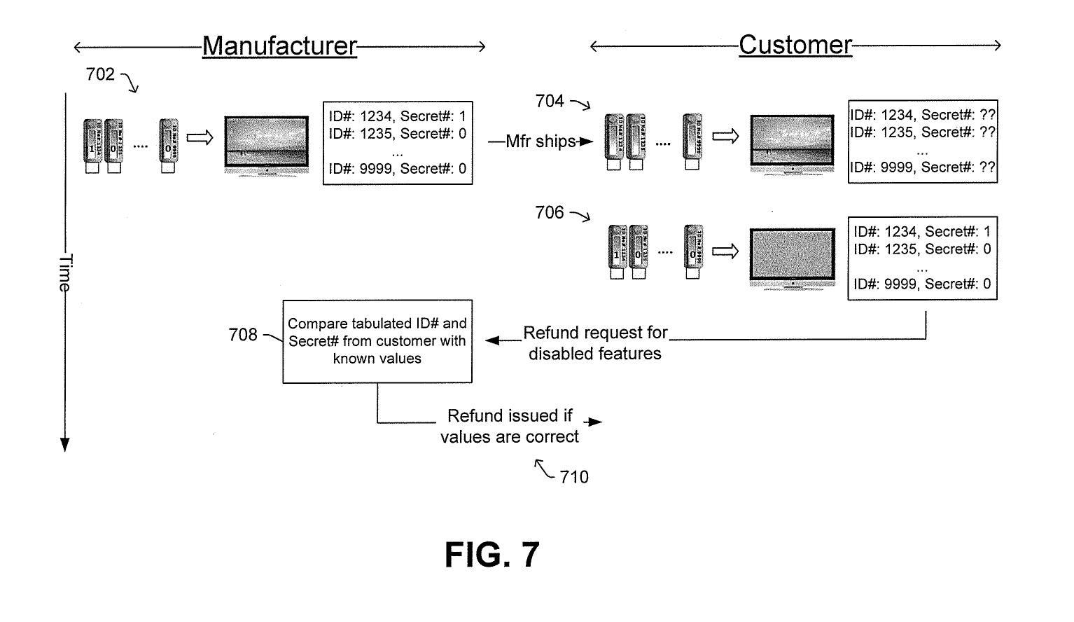

FIG. 7 illustrates an exemplary scenario where a commercial customer (e.g., a chain of electronics stores) buys a large batch of electronics devices in the form of memory sticks that include an enabled feature (e.g., a movie) from a manufacturer.

At 702, prior to distributing the memory sticks to the commercial customer, the manufacturer (or other OEM who, for example, loads the movie into the memory sticks), may assign and read the secret values associated with the enabled movies for the devices. The manufacturer may use a manufacturing tool, such as an IC tester, to assign/program secret values into the chip, or circuitry on the chip itself (e.g., BIST circuitry) may assign/program the secret values (e.g., random or pseudo-random values) into the chip. Whatever the case, the manufacturer or OEM may read and tabulate the secret values and the corresponding device or chip IDs, and may then ship the batch of devices to the customer. Just prior to shipping, the manufacturer enables a security feature on the each memory stick (e.g., by blowing a verification element 316—FIG. 3 or 602—FIG. 6), which prevents the customer from reading the secret values so long as the movie is enabled.

When the customer initially receives the devices at 704, the feature (e.g., movie content) is enabled on the devices. Hence, all individuals who purchase devices from the customer at this time have the functionality enabled and are capable of viewing the movie content for their devices in this example. So long as the feature is enabled on a given device, the secret number corresponding to the feature on that device is unable to be read.

Subsequently, the customer may determine that it wants to disable the feature, for example if the movie isn't selling well or is otherwise of no further use. When the customer disables the feature for the remaining unsold devices at 706, it may create a table of values that lists the device or chip IDs along with corresponding secret numbers for the now disabled features. The customer provides this tabulated data to the manufacturer, who then verifies that the device or chip IDs and secret numbers are correct in block 708.

For the disabled features that are correctly verified, the manufacturer may send the customer a refund in 710. In the example of FIG. 7, the secret value may be a single or limited number of bits because it is assumed that the commercial customer will return a large enough quantity to make the single or limited number of bits statistically difficult to guess. Therefore, even though each secret number is a single bit, the large number of devices (and corresponding large number of single bits) makes it difficult to guess appropriate values for the secret numbers and thus deters commercial customers from attempting to defraud the manufacturer. Multi-bit secret values could also be used.

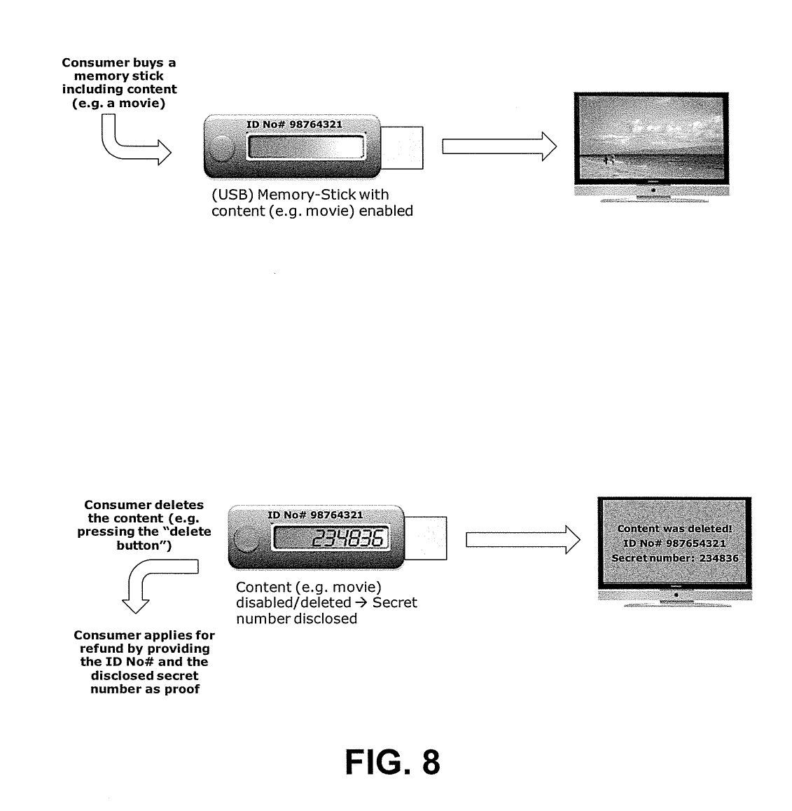

FIG. 8 illustrates another example where the secret number has a large number of bits, which is more suitable for use with individual consumers. In FIG. 8 the manufacturer provides an electronic device with an enabled feature (e.g., a movie). Again, so long as the feature is enabled, the customer is free to use the feature, but is unable to request a refund because a security circuit prevents the customer from reading a secret number associated with the feature. If the customer disables the feature (e.g., by pressing a disable/delete button), the device provides the consumer with the device or chip ID number along with the secret number corresponding to the disabled feature. The customer may then apply for a refund by submitting the device or chip ID and secret number to the manufacturer. Refund requests could be made over the phone, over the internet (e.g., a webserver interface or email interface), over an SMS message, via the mail, or any other medium.

In some embodiments, these disabling techniques may be used in conjunction with a feature enabling mechanism. In such embodiments, the OTP memory elements may be replaced with non-volatile memory cells to allow the re-activation of features or there can be multiple levels of fuses. This would effectively allow a customer to “rent” a feature. In such cases, an integrated trusted module may, upon a request for reactivation of a feature, re-program new secret numbers into a trusted element so long as the customer is able to input some additional secret information provided by the manufacturer to re-activate the feature. This additional secret information from the manufacturer may provide the manufacturer with some assurances that the features are not re-enabled without the customer re-paying for the feature. The re-activated feature could then be subsequently deactivated by the customer (requiring the customer to read the new secret numbers from the trusted element which was previously unreadable to the customer, if the customer requires a re-fund), and so on.

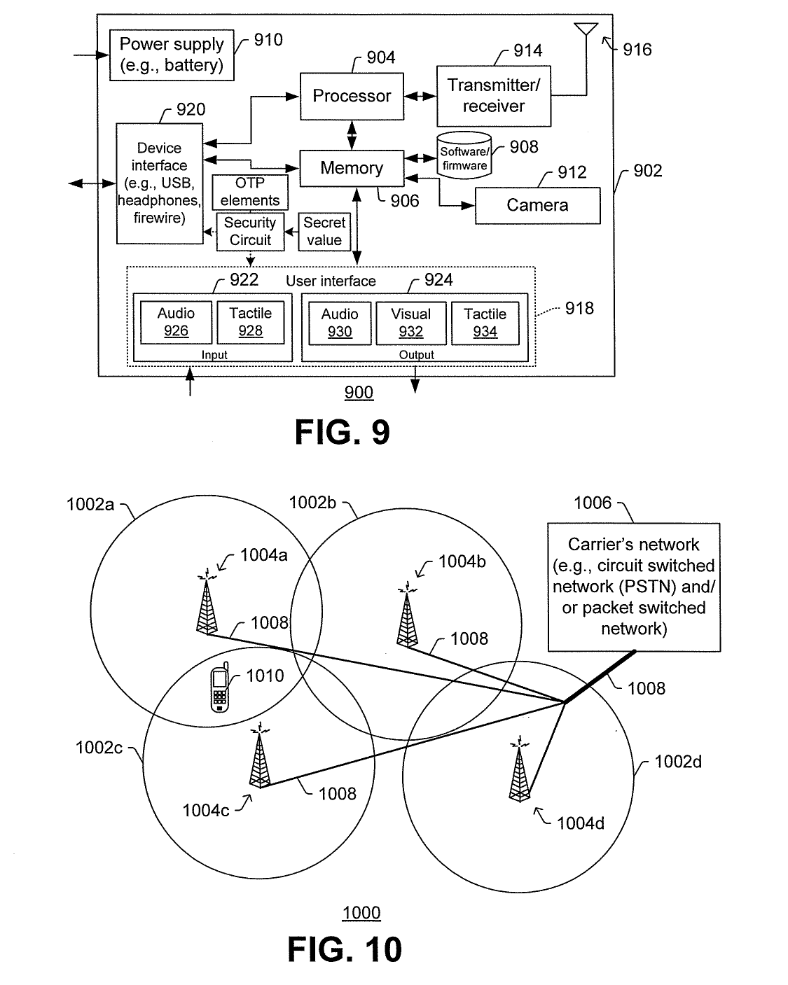

FIG. 9 and the following discussion provide a brief, general description of a suitable mobile communication device 902 to implement embodiments of one or more of the provisions set forth herein. Mobile communication device 902 is merely one possible device on which feature disabling techniques as set forth above may be used, and it will be appreciated that the feature disabling techniques may also be used with other devices (e.g., individual digital chip sets, mixed-signal chip sets, and/or analog chip sets). Thus, mobile communication device 902 is only one example of a suitable operating environment and is not intended to suggest any limitation as to the scope of use or functionality of the operating environment. Example mobile communication devices include, but are not limited to, mobile devices (such as mobile phones, Personal Digital Assistants (PDAs), media players, and the like), tablets, personal computers, server computers, hand-held or laptop devices, multiprocessor systems, consumer electronics, mini computers, mainframe computers, distributed computing environments that include any of the above systems or devices, and the like.

FIG. 9 illustrates an example of a system 900 comprising a mobile communication device 902, such as a mobile phone handset for example, configured to implement one or more embodiments provided herein. In one configuration, mobile communication device 902 includes at least one processing unit 904 and memory 906. Depending on the exact configuration and type of mobile communication device, memory 906 may be volatile (such as RAM, for example), non-volatile (such as ROM, flash memory, etc., for example) or some combination of the two. Memory 906 may be removable and/or non-removable, and may also include, but is not limited to, magnetic storage, optical storage, and the like. In some embodiments, computer readable instructions in the form of software or firmware 908 to implement one or more embodiments provided herein may be stored in memory 906. Memory 906 may also store other computer readable instructions to implement an operating system, an application program, and the like. Computer readable instructions may be loaded in memory 906 for execution by processing unit 904, for example. Other peripherals, such as a power supply 910 (e.g., battery) and a camera 912 may also be present.

Processing unit 904 and memory 906 work in coordinated fashion along with a transmitter and/or receiver 914 to wirelessly communicate with other devices. To facilitate this wireless communication, a wireless antenna 916 is coupled to transmitter/receiver 914. During wireless communication, transmitter/receiver 914 may use frequency modulation, amplitude modulation, phase modulation, and/or combinations thereof to communicate signals to another wireless device, such as a base station for example. The previously described high resolution phase alignment techniques are often implemented in processor 904 and/or transmitter/receiver 914 (possibly in conjunction with memory 906 and software/firmware 908) to facilitate accurate data communication. However, the high resolution phase alignment techniques could also be used in other parts of the mobile communication device.

To improve a user's interaction with mobile communication device 902, mobile communication device 902 may also include a number of interfaces that allow mobile communication device 902 to exchange information with the external environment. These interfaces may include one or more user interface(s) 918, and one or more device interface(s) 920, among others.

If present, user interface 918 may include any number of user inputs 922 that allow a user to input information into mobile communication device 902, and may also include any number of user outputs 924 that allow a user to receive information from mobile communication device 902. In some mobile phone embodiments, the user inputs 922 may include an audio input 926 (e.g., a microphone) and/or a tactile input 928 (e.g., push buttons and/or a keyboard). In some mobile phone embodiments, the user outputs 924 may include an audio output 930 (e.g., a speaker), a visual output 932 (e.g., an LCD or LED screen), and/or tactile output 934 (e.g., a vibrating buzzer), among others.

Device interface 920 allows mobile communication device 902 to communicate with other electronic devices. Device interface 920 may include, but is not limited to, a modem, a Network Interface Card (NIC), an integrated network interface, a radio frequency transmitter/receiver, an infrared port, a USB connection, or other interfaces for connecting mobile communication device 902 to other mobile communication devices. Device connection(s) 920 may include a wired connection or a wireless connection. Device connection(s) 920 may transmit and/or receive communication media.

To allow customers to customize what features are enabled/disabled, mobile communication device 902 also includes a security circuit 936 as previously described. Thus, security circuit 936 can selectively allow a customer to read a secret value 938 stored in mobile communication device 902, based on a state(s) of OTP elements 940. If a feature on mobile communication device 902 is enabled, security circuit 936 prevents a customer from reading secret value 938. However, when the feature is disabled, security circuit 936 can then allow the user to read secret value 938 via device interface 920 and/or user interface 918, for example. Secret value 938 can be stored in dedicated memory elements, such as fuses, but can also be stored in memory 906 depending on the implementation.

FIG. 10 shows one embodiment of a wireless network 1000 over which a mobile communication device (e.g., mobile communication device 902 in FIG. 9) in accordance with this disclosure may communicate. The wireless network 1000 is divided into a number of cells (e.g., 1002a, 1002b, . . . , 1002d), wherein each cell has one or more base stations (e.g., 1004a, 1004b, . . . , 1004d, respectively). Each base station may be coupled to a carrier's network 1006 (e.g., a packet switched network, or a circuit switched network such as the public switched telephone network (PSTN)) via one or more wirelines 1008.

A mobile handset 1010 (e.g., mobile communication device 902) or other mobile device that allows a customer to perform chip functionality customization, while residing within a given cell, may establish communication with the base station within that cell via one or more of frequency channels used for communication in that cell. The communication between a mobile handset or other mobile device 1010 and a corresponding base station often proceeds in accordance with an established standard communication protocol, such as LTE, GSM, CDMA or others. When a base station establishes communication with a mobile handset or other mobile device, the base station may establish communication with another external device via the carrier's network 1006, which may then route communication though the phone network.

Those skilled in the art will realize that mobile communication devices such as mobile phones may in many instances upload and download computer readable instructions from a network through the base stations. For example, a mobile handset or other mobile device 1010 accessible via network 1006 may store computer readable instructions to implement one or more embodiments provided herein. The mobile handset or other mobile device 1010 may access a network and download a part or all of the computer readable instructions for execution.

The term “computer readable media” as used herein includes computer storage media. Computer storage media includes volatile and nonvolatile, removable and non-removable media implemented in any method or technology for storage of information such as computer readable instructions or other data. Memory (e.g., 906 in FIG. 9) is an example of computer storage media. Computer storage media includes, but is not limited to, RAM, ROM, EEPROM, flash memory or other memory technology, CD-ROM, Digital Versatile Disks (DVDs) or other optical storage, magnetic cassettes, magnetic tape, magnetic disk storage or other magnetic storage devices, or any other medium which may be used to store the desired information. The term “computer readable media” may also include communication media. Communication media typically embodies computer readable instructions or other data in a “modulated data signal” such as a carrier wave or other transport component and includes any information delivery media. The term “modulated data signal” may include a signal that has one or more of its characteristics set or changed in such a manner as to encode information in the signal.

Although the disclosure has been shown and described with respect to one or more implementations, equivalent alterations and modifications will occur to others skilled in the art based upon a reading and understanding of this specification and the annexed drawings. Further, it will be appreciated that identifiers such as “first” and “second” do not imply any type of ordering or placement with respect to other elements; but rather “first” and “second” and other similar identifiers are just generic identifiers. In addition, it will be appreciated that the term “coupled” includes direct and indirect coupling. The disclosure includes all such modifications and alterations and is limited only by the scope of the following claims. In particular regard to the various functions performed by the above described components (e.g., elements and/or resources), the terms used to describe such components are intended to correspond, unless otherwise indicated, to any component which performs the specified function of the described component (e.g., that is functionally equivalent), even though not structurally equivalent to the disclosed structure which performs the function in the herein illustrated exemplary implementations of the disclosure. In addition, while a particular feature of the disclosure may have been disclosed with respect to only one of several implementations, such feature may be combined with one or more other features of the other implementations as may be desired and advantageous for any given or particular application. In addition, the articles “a” and “an” as used in this application and the appended claims are to be construed to mean “one or more”.

Furthermore, to the extent that the terms “includes”, “having”, “has”, “with”, or variants thereof are used in either the detailed description or the claims, such terms are intended to be inclusive in a manner similar to the term “comprising.”

What is claimed is:

1. An electronic device, comprising:
a feature associated with a hardware module, wherein the hardware module has an enable terminal to control whether the feature is enabled or disabled;
an enabling element coupled to the enable terminal, the enabling element having a state;
a trusted element configured to store a secret value; and
a security circuit configured to, based on the state of the enabling element, selectively prevent or allow reading of the secret value from the trusted element.

2. The electronic device 1, wherein the secret value corresponds to a deactivation code for the feature.

3. The electronic device of claim 1, wherein the security circuit is configurable to prevent reading of the secret value when the feature is enabled.

4. The electronic device of claim 3, wherein the security circuit is configurable to allow reading of the secret value when the feature is disabled.

5. The electronic device of claim 1, wherein the enabling element comprises a one-time-programmable element.

6. The electronic device of claim 1, wherein the trusted element comprises a one-time-programmable element.

7. The electronic device of claim 1, wherein the secret value is a single-bit value.

8. The electronic device of claim 1, wherein the secret value is a multi-bit value.

9. An electronic device, comprising:
a first feature associated with a first hardware module having a first enable terminal;
a first enabling one-time-programmable (OTP) element coupled to the first enable terminal, wherein a state of the first enabling OTP element determines whether the first feature is enabled or disabled;
a first trusted OTP element that stores a first secret value; and
a first security circuit having first and second input terminals coupled to the first enabling OTP element and first trusted OTP element, respectively, wherein the first security circuit prevents reading of the first secret value when the first feature is enabled and wherein the first security circuit allows reading of the first secret value when the first feature is disabled.

10. The electronic device of claim 9, wherein the first enabling OTP element comprises a fuse, and wherein the first feature is enabled when the fuse is not blown.

11. The electronic device of claim 10, wherein the first feature is disabled when the fuse is blown.

12. The electronic device of claim 10, wherein the fuse comprises at least one of: an antifuse, a poly-fuse, or a laser fuse.

13. The electronic device of claim 9, further comprising:
a verification OTP element,
wherein the first security circuit is configured to selectively prevent reading of the first secret value based on a state of the verification OTP element.

14. The electronic device of claim 9, further comprising:
a second feature associated with a second hardware module, wherein the second hardware module has a second enable terminal;
a second enabling one-time-programmable (OTP) element coupled to the second enable terminal, the second enabling OTP element having a state that controls whether the second feature is enabled or disabled;
a second trusted OTP element configured to store a second secret value; and
a second security circuit configured to, based on the state of the second enabling OTP element, selectively prevent or allow reading of the second secret value.

15. The electronic device of claim 14, further comprising:
a verification OTP element;
wherein the first and second security circuits are configured to selectively prevent reading of the first and second secret values, respectively, based on a state of the verification OTP element.

16. The electronic device of claim 15, wherein at least one of the first OTP elements, second OTP elements, and verification OTP element is one of a fuse, anti-fuse, poly-fuse, and laser fuse.

17. A method, comprising:
providing an electronic device having a security circuit and one or more enabled features; where, so long as a feature remains enabled, the security circuit prevents or limits reading of a secret number associated with the feature;
receiving a refund request for disablement of the feature after the feature has been allegedly disabled, wherein the refund request identifies the electronic device and an alleged secret number associated with the feature; and
verifying the alleged secret number corresponds to the secret number prior to issuing a refund for disablement of the feature.

18. The method of claim 17, further comprising:
instructing a customer to disable one of more of the enabled features line by changing a state of an enabling element on the electronic device.

19. The method of claim 17, wherein the security circuit does not use a cryptographic algorithm to prevent a customer from reading a plaintext version of the secret number.

20. The method of claim 17, further comprising:
receiving a re-activation request to re-activate the feature; and
randomly or pseudo-randomly changing the secret number based on the re-activation request.

21. A mobile handset, comprising:
a processor;
a memory;
a hardware module associated with a feature, wherein the hardware module has an enable terminal;
an enabling one-time-programmable (OTP) element coupled to the enable terminal, the enabling OTP element having a state that controls whether the feature is enabled or disabled;
a trusted OTP element configured to store a secret value; and
a security circuit configured to, based on the state of the enabling OTP element, selectively prevent or allow reading of the secret value.

22. A method, comprising:
receiving an electronic device having a security circuit and one or more enabled features;
disabling the feature;
reading a first secret number from the electronic device after the feature has been disabled; and
submitting a refund request that includes the first secret number.

23. The method of claim 22, further comprising:
re-enabling the feature after disabling the feature;
disabling the re-enabled feature;
reading a second secret number after the re-enabled feature has been disabled; and
submitting a second refund request that includes the second secret number.
